(19) United States
(12) Patent Application Publication
(10) Pub. No.: US 2012/0067374 A1
(43) Pub. Date: Mar. 22, 2012

(54) Vacuum Storage Bag Having Assorted Monitoring Means

(75) Inventor: Reza P. RASPATI, Jawa Barat (ID)

(73) Assignee: Avery Dennison Corporation, Pasadena, CA (US)

(21) Appl. No.: 13/238,385

(22) Filed: Sep. 21, 2011

Related U.S. Application Data
(60) Provisional application No. 61/384,739, filed on Sep. 21, 2010.

(51) Int. Cl. B08B 5/04; A47L 9/14

(52) U.S. Cl. 134/21; 15/246.2

(57) ABSTRACT

An improved vacuum storage bag having assorted monitoring means and a method of using the same. The vacuum storage bag is comprised of a flexible impermeable bag that has a storage area and a storage area access opening. A valve is provided to the bag that is in fluid communication with the storage area. Resealable sealing means extend across the storage area access opening. The resealable sealing means are capable or repeatedly allowing the storage area to be selectively maintained in a substantially hermetically sealed on unsealed condition. One-time-use sealing means extend across the storage area parallel to the resealable sealing means. The vacuum storage bag further has a radio frequency identification tag that extends substantially across said storage area access opening. In an alternative embodiment of the vacuum storage bag, the radio frequency identification tag is replaced with tamper indicating means.

### CROSS REFERENCE TO RELATED APPLICATION

The present application claims the benefit of U.S. Provisional Application No. 61/384,739 filed Sep. 21, 2010, which is incorporated herein by reference in its entirety.

### FIELD OF THE INVENTION

A vacuum storage bag is disclosed. More particularly, the present invention relates to an improved vacuum storage bag that is provided with an assortment of mechanisms that enable a worker to ascertain the condition of the bag. The vacuum storage bag may be provided with tamper indicating means in the form of an RFID tag that changes frequency once the vacuum storage bag has been opened. Alternatively visual tamper indicating means may be provided that visually alert a worker that the vacuum storage bag has been opened. The vacuum storage bag may be provided with moisture sensing means and vacuum indicating means to allow a worker to monitor the conditions inside the bag.

### BACKGROUND OF THE INVENTION

The use of vacuum storage bags is well known. Typically, vacuum storage bags are used to store items such as food or articles of clothing. Using a vacuum storage bag to store items provides several benefits. First, the item stored within the bag is cut off from exposure to air. This is especially beneficial when storing food, as removing food from air reduces the rate at which the food will spoil or become stale. Next, the size of items stored within the vacuum storage bag will be reduced, thus allowing for more items to be stored within a smaller space. This is especially true with items that naturally have a lot of air space that can be compressed (i.e. down jackets, comforters, etc.). Finally, the items stored within the vacuum storage bag are protected against outside atmospheric elements such as humidity. This is beneficial to both food products and articles of clothing, as food that is stored in humid conditions will more rapidly spoil or become stale, while clothing stored in humid conditions may begin to smell musty.

One issue with current vacuum storage bags is that a bag may be unknowingly tampered with. This problem is most applicable to vacuum storage bags that have selectively resealable sealing means. This is problematic, as the vacuum storage bag may be opened, and contaminants may be introduced to the items stored within the vacuum storage bag. Furthermore, the vacuum storage bag may be opened and a portion of the items stored within the bag may be removed. Once the vacuum storage bag has been tampered with, the selectively resealable sealing means may be resealed, and the vacuum storage bag may again be evacuated without any noticeable visual indications that the bag has been tampered with. The only way to ensure that the bag has not been tampered with is to open the vacuum storage bag and inspect the stored items. However, this process can be time consuming and is inefficient.

To overcome this issue, a vacuum storage bag having one-time-use sealing means may be employed. However, such vacuum storage bags are problematic, as they generally cannot not be reused once the one-time-use sealing means have been unsealed. Presently, there are some vacuum storage bag designs that utilize one-time-use sealing means that can be resealed, however these designs require that the one-time-use sealing means be cut off from the main body of the vacuum storage bag each time the bag is opened. Cutting off the one-time-use sealing means decreases the size of the vacuum storage bag. Once it is desired to reseal the vacuum storage bag, the one-time-use sealing means are again applied to the bag. However, as noted above, to open the vacuum storage bag a portion of the bag must be cut off, thus reducing the size of the vacuum storage bag. Therefore, the overall storage capacity of the vacuum storage bag is reduced each time the bag is opened. Eventually, the vacuum storage bag will have a storage capacity that is so small as to be unusable.

Furthermore, no current vacuum storage bags offer the ability to monitor the conditions within the bag once the bag has been sealed. Accordingly, a vacuum storage bag may develop a leak unbeknownst to a user of the bag. The vacuum storage bag may slowly begin to lose the desired vacuum within the bag, thereby potentially allowing damage to occur to items stored inside the bag.

In light of the above-identified problems associated with current vacuum bag offerings, what is needed is an improved vacuum storage bag.

### BRIEF SUMMARY OF THE INVENTION

By providing an improved vacuum storage bag that can be reused, indicates whether the bag has been tampered with, and monitors the conditions within the vacuum storage bag, the present invention overcomes the issues identified above that hinder current vacuum storage bag designs.

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

The present invention relates to improved vacuum storage bags and methods of using the same. In a first embodiment of the vacuum storage bag, that vacuum storage bag comprises a flexible, impermeable bag having a first panel and a second panel. The first panel and the second panel are hermetically sealed to one another along a first panel periphery and a second panel periphery to define a storage area between the first panel and the second panel. A storage area access opening is provided along the first panel periphery and the second panel periphery where the two are not hermetically sealed to one another. The vacuum storage bag further has a valve in fluid communication with the storage area. The valve protrudes from a valve opening provided on the first panel. The valve is hermetically sealed to the valve opening. Resealable sealing means extend across the storage area access opening. One-time-use sealing means extend across the storage area opening parallel to the resealable sealing means. A tear strip extends across the storage area access opening. The tear strip is positioned between the resealable sealing means and the one-time-use sealing means. A radio frequency identification tag extends across the storage area access opening. In a second embodiment of the vacuum storage bag, the vacuum storage bag is provided with tamper indicating means as opposed to the radio frequency identification tag.

The present invention also relates to a method of using the improved vacuum storage bag. The method comprises the steps of first, providing a flexible impermeable bag having a storage area, a storage area access opening, a valve, resealable sealing means, one-time-use sealing means, a radio frequency identification tag, and a tear strip. Next, the method includes the step of placing an article within the storage area through the storage area access opening. Then, sealing the resealable sealing means and the one-time-use sealing means. Next, a vacuum source is attached to the valve and all air from the storage area is evacuated using the vacuum source. Finally, the method concludes with the step of removing the vacuum source from the valve. In another method of using the improved vacuum storage bag, in the step of providing a flexible impermeable bag, the vacuum storage bag is provided with tamper indicating means as opposed to the radio frequency identification tag.

Other features and advantages of the present invention will become apparent to those skilled in the art from the following detailed description. It is to be understood, however, that the detailed description of the various embodiments and specific examples, while indicating preferred and other embodiments of the present invention, are given by way of illustration and not limitation. Many changes and modifications within the scope of the present invention may be made without departing from the spirit thereof, and the invention includes all such modifications.

### BRIEF DESCRIPTION OF THE DRAWINGS

These, as well as other objects and advantages of this invention, will be more completely understood and appreciated by referring to the following more detailed description of the presently preferred exemplary embodiments of the invention in conjunction with the accompanying drawings, of which:

FIG. 1 is a top view of a first embodiment of a vacuum storage bag of the present invention;

FIG. 2 is a perspective view of the vacuum storage bag shown in FIG. 1 showing the vacuum storage bag in a fully expanded condition;

FIG. 3 is a top view of a second embodiment of a vacuum storage bag of the present invention;

FIG. 4 is a perspective view of the vacuum storage bag shown in FIG. 4 showing the vacuum storage bag in a fully expanded condition; and

FIG. 5 is a top view of a portion of the vacuum storage bag shown in FIG. 1 in an unassembled condition.

FIG. 6 is a top view of a portion of the vacuum storage bag shown in FIG. 3 in an unassembled condition.

### DETAILED DESCRIPTION OF THE INVENTION

The apparatuses and methods disclosed in this document are described in detail by way of examples and with reference to the figures. Unless otherwise specified, like numbers in the figures indicate references to the same, similar, or corresponding elements throughout the figures. It will be appreciated that modifications to disclosed and described examples, arrangements, configurations, components, elements, apparatuses, methods, materials, etc. can be made and may be desired for a specific application. In this disclosure, any identification of specific shapes, materials, techniques, arrangements, etc. are either related to a specific example presented or are merely a general description of such a shape, material, technique, arrangement, etc. Identifications of specific details or examples are not intended to be, and should not be, construed as mandatory or limiting unless specifically designated as such.

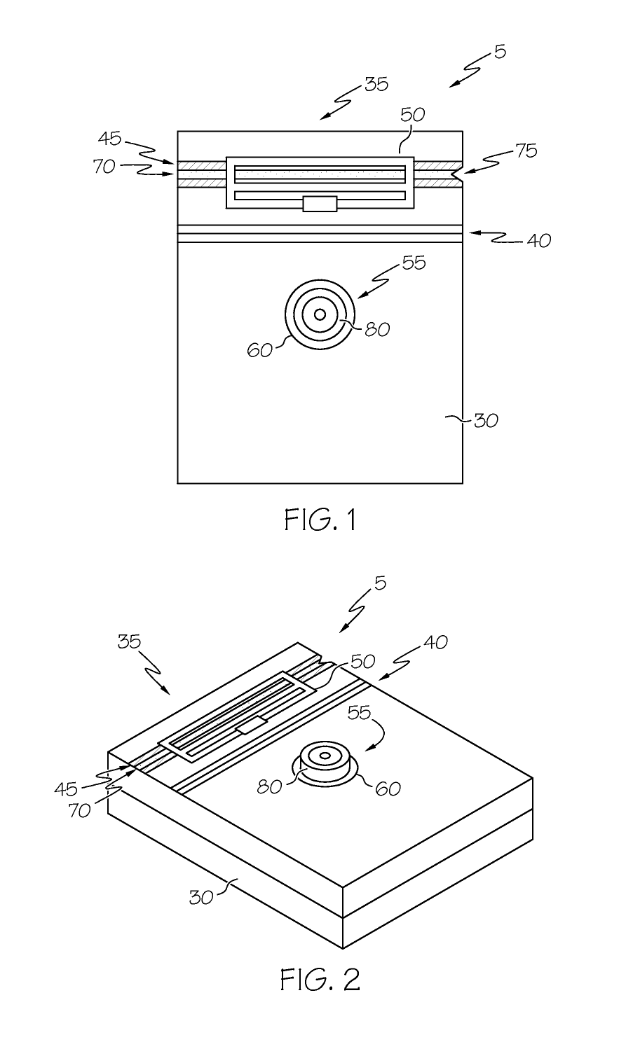

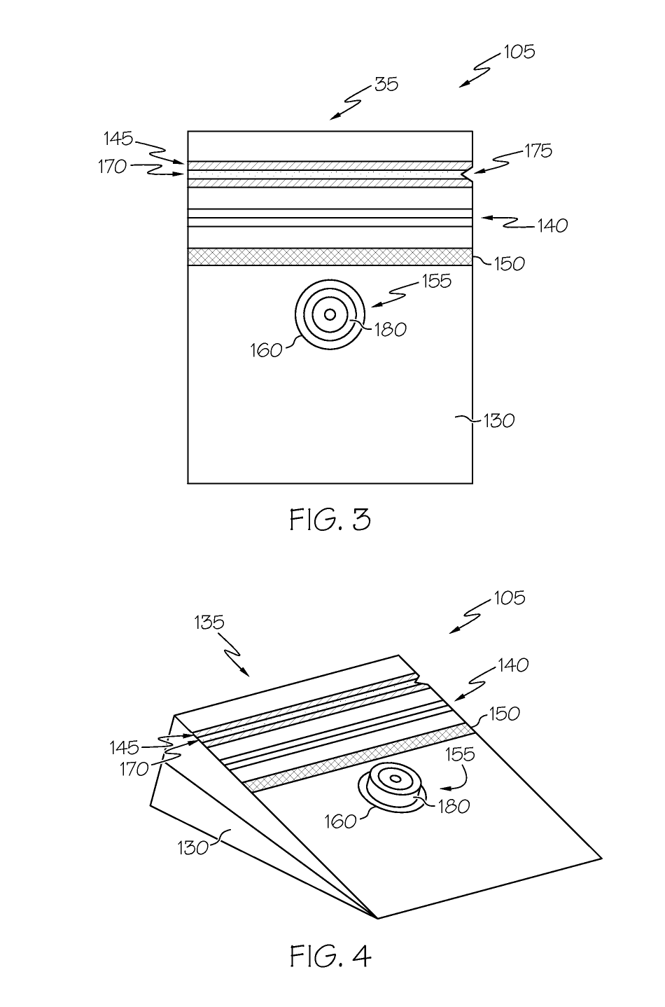

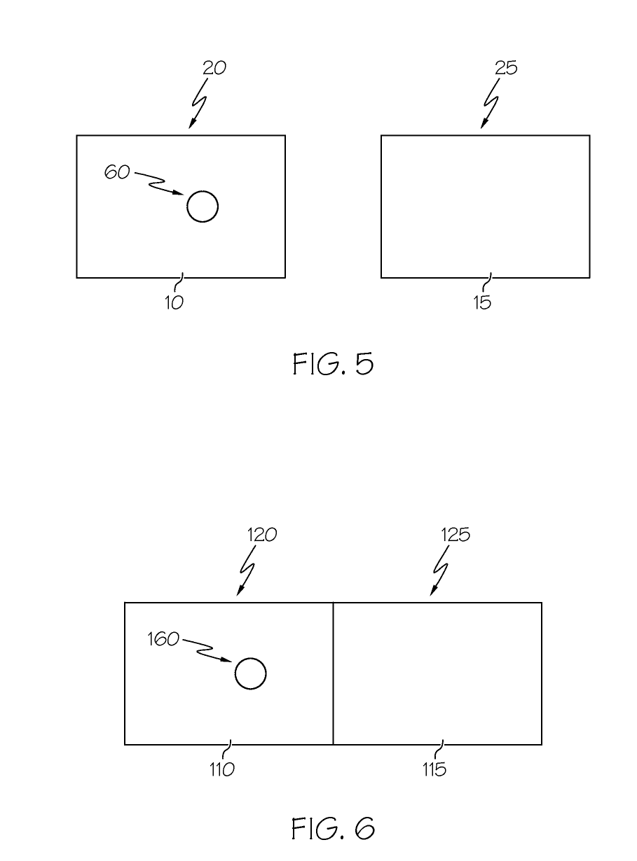

Referring now to FIGS. 1, 2, and 5 a first embodiment of a vacuum storage bag 5 is shown. When fully expanded, the vacuum storage bag 5 has a substantially rectangular parallelepiped shape. It is contemplated that shape and the dimensions of the vacuum storage bag 5 may be altered as appropriate to more suitably contain the article or articles that may be placed in the vacuum storage bag 5. The vacuum storage bag 5 has a first panel 10 and a second panel 15. The first panel 10 and the second panel 15 may be manufactured separately apart from one another as two separate sheets. Alternatively, it is contemplated that the first panel 10 and the second panel 15 may be manufactured together as a single sheet, as will be explained below in reference to a second embodiment of a vacuum storage bag 105 shown in FIGS. 3, 4 and 6. However, as can most clearly be seen in FIG. 5, in the first embodiment of the vacuum storage bag 5, the first panel 10, and the second panel 15 are manufactured separately apart from one another as two separate sheets.

Preferably, the first panel 10 and the second panel 15 are manufactured out of transparent single layer polyethylene. However, the first panel 10 and the second panel 15 may be made out of any suitable material that is both flexible and impermeable to both air and water. Such materials may include, but are not limited to, polypropylene, polyvinylidene chloride, nylon, ethylene vinyl acetate, polyester, or ethylene vinyl alcohol. Furthermore, the first panel 10 and the second panel 15 may be made out of appropriate biodegradable materials. It is contemplated that the first panel 10 and the second panel 15 may be provided with more than one layer of material.

The first panel 10 has a first panel periphery 20, while the second panel 15 has a second panel periphery 25. The first panel periphery 20 and the second panel periphery 25 are hermetically sealed to one another along a substantial portion of the first panel periphery 20 and the second panel periphery 25, thereby creating a storage area 30 between the first panel 10 and the second panel 15. Preferably, the hermetic seal is created by way of heat-sealing together the first panel periphery 20 and the second panel periphery 25. However, any other suitable means may be employed to achieve the necessary hermetic seal. A storage area access opening 35 is provided along the portions of the first panel periphery 20 and the second panel periphery 25 that are not hermetically sealed to one another.

The vacuum storage bag 5 has a valve 55. The valve 55 protrudes from, and is hermetically sealed to, a valve opening 60 provided on the first panel 10. The valve 5 is preferably a simple one-way valve, however other valve constructions may be employed so long as the valve construction is able to maintain an airtight and watertight seal. The valve 55 has a valve collar 80. The valve collar 80 is preferably made out of a flexible, resilient material. It is contemplated that the valve 55 may be provided with a protective valve cover (not shown) that attaches to the valve collar 80.

The vacuum storage bag 5 is provided with resealable sealing means 40. The resealable sealing means 40 extend across the storage area access opening 35. In the first embodiment of the vacuum storage bag 5 shown in FIGS. 1, 2, and 5, the resealable sealing means 40 consists of a series of interlocking ribs and channels that extend lengthwise across the storage area access opening 35. However, any other suitable resealable sealing means 40 may be used. For example, the vacuum storage bag 5 may be provided with an interlocking zipper.

The first panel 10 is provided with two ribs that run parallel to one another, while the second panel 15 is provided with two channels that are complementary to the ribs. Similar to the ribs, the two channels run parallel to one another. Alternatively, the ribs may be provided on the second panel 15, and the channels may be provided on the first panel 10. The ribs and channels may be formed integrally during the manufacture of the first panel 10 and the second panel 15. However, the ribs and channels also may be manufactured separately from the first panel 10 and the second panel 15, and then later be permanently attached to the first panel 10 and the second panel 15.

It is contemplated that this basic resealable sealing means arrangement may be modified as necessary to achieve various manufacturing cost goals and vacuum retention goals. For example, if a more robust seal is desired, a vacuum storage bag may be provided with three or more interlocking ribs and channels. While the presence of three channels and ribs will increase the vacuum retention of the vacuum storage bag, the costs of manufacturing such a vacuum storage bag will be increased. Similarly, providing a vacuum storage bag with only a single channel and a single rib will decrease the manufacturing costs. However, the resulting vacuum storage bag will have lower vacuum retention when compared to vacuum storage bags having two ore more channels and two or more ribs.

One-time-use sealing means 45 are provided to the vacuum storage bag 5 adjacent to the resealable sealing means 40. The one-time-use sealing means 45 extend across the storage area access opening 35, and run parallel to the resealable sealing means 40. The one-time-use sealing means 45 are located further from the storage area 30 than the resealable sealing means 40. In the first embodiment of the vacuum storage bag 5 shown in FIGS. 1, 2, and 5, the one-time-use sealing means 45 consist of a pressure sensitive adhesive. However, any other suitable one-time-use sealing means may be used. For example, the one-time-use sealing means 45 may consist of a heat seal.

A tear strip 70 extends across the storage area access opening 35. The tear strip 70 is simply a portion of the first panel 10 and the second panel 15 that is thinner, and thus weaker. The tear strip 70 is located between the resealable sealing means 40 and the one-time-use sealing means 45. A tear notch 75 is provided at one end of the tear strip 70.

The vacuum storage bag 5 further has a radio frequency identification tag 50. The radio frequency identification tag 50 extends substantially across the storage area access opening 35. The radio frequency identification tag 50 is positioned collinearly with the tear strip 70 such that the tear strip 70 intersects a portion of the radio frequency identification tag 50.

Having now described the layout of the first embodiment of the vacuum storage bag 5, the use of the vacuum storage bag 5 will now be explained. First, it will be explained how the vacuum storage bag 5 is used to vacuum seal an article. The vacuum storage bag 5 will be provided to a worker in a completely deflated, flat condition so as to conserve space during the shipping of the vacuum storage bag 5. To begin using the vacuum storage bag 5, a worker takes the vacuum storage bag 5 and separates the first panel 10 and the second panel 15 from one another to expand the storage area 30, thereby maximizing the volumetric capacity of the storage area 30. As the worker separates the first panel 10 from the second panel 10 to expand the storage area 30, the storage area access opening 35 will likewise naturally expand, thereby allowing the worker to freely access the storage area 30.

Next, the worker inserts an article through the storage area access opening 35 and into the storage area 30. For the purposes of this discussion, it will be assumed that the article to be stored inside the vacuum storage bag 5 is a down jacket. Preferably, the worker will place the jacket at the center of the storage area 30. However, successful use of the vacuum storage bag 5 does not necessitate such a placement.

With the jacket placed inside the storage area 30 of the vacuum storage bag 5, the worker next begins disassociating the storage area 30 from the atmosphere external to the vacuum storage bag 5 by first sealing the resealable sealing means 40, and then the one-time-use sealing means 45. However, before sealing the resealable sealing means 40 and the one-time-use sealing means 45, it is recommended that the worker flatten the vacuum storage bag 5 around the jacket to expel a majority of the air from the storage area 30. This optional step increases the rate at which articles may be packaged in the vacuum storage bag 5, as flattening the vacuum storage bag 5 will result in less air for the vacuum source to remove from the storage area 30. Thus, there will be less downtime, as the worker will not have to wait as long for the vacuum source to vacate all the air from the storage area 30.

To seal the resealable sealing means 40 the worker aligns the ribs provided on the first panel 10 with the complementary channels provided on the second panel 15. Aligning the ribs with the channels should be a relatively quick, simple, and straightforward task, as the ribs and channels are provided directly across from one another on the first panel 10 and the second panel 15, respectively. Accordingly, the ribs should naturally fall into alignment with the complementary channels as the worker flattens the vacuum storage bag 5 around the jacket. Once the ribs are aligned with the channels, the worker pushes down on the ribs to snap the rips into the channels, thereby creating a substantially hermetic seal.

To seal the one-time-use sealing means 45, the worker simply applies pressure to the portions of the first panel 10 and the second panel 15 that surround the one-time-use sealing means 45. Because the one-time-use sealing means 45 in the first embodiment of the vacuum storage bag 5 consist of a pressure sensitive adhesive, the application of pressure activates the pressure sensitive adhesive, thereby creating a hermetic seal.

While the presence of two sealing means may seem redundant, both sealing means are necessary to achieve the dual goals of providing a vacuum storage bag that is able to provide a hermetic seal while also being reusable. As noted above, the resealable sealing means 40 provide a substantially hermetic seal, meaning that the resealable sealing means 40 are able sustain a vacuum for an extended, but not infinite, period of time. In the embodiment of the vacuum storage bag shown in FIGS. 1, 2, and 5 the interlocking ribs and channels provided for the resealable sealing means 40 have been found to be able to sustain a vacuum for a period of approximately one month. Despite the best efforts to design and implement resealable sealing means that are capable of maintaining a vacuum for an infinite amount of time, no such system has yet been devised. Accordingly, to establish a truly hermetic seal, the presence of the one-time-use sealing means 45 is required.

Once the resealable sealing means 40 and the one-time-use sealing means 45 have been sealed, the worker next attaches a vacuum source to the vacuum storage bag 5 via the valve 55. The vacuum source is retained to the valve 55 by the valve collar 80. As discussed above, the valve collar 80 is made out a flexible, resilient material. Using a flexible, resilient material to manufacture the valve collar 80 allows the valve collar 80 to adapt to vacuum sources having a wide variety of different shapes and sizes while also maintaining a tight seal between the valve 55 and the vacuum source.

Once the vacuum source has been securely connected to the valve 55, the worker can then turn on the vacuum source to evacuate the remaining air contained within the storage area 30 of the vacuum storage bag 5. Once the storage area 30 has been completely evacuated of air, the operator may remove the vacuum source from the valve 55. Because the valve 55 is a simple one-way valve, the valve 55 will automatically self-seal once the vacuum source is removed. If the valve 55 is provided with a protective valve cover, the worker may then attach the protective valve cover 55 to the valve to further increase the robustness of the seal provided by the valve 55, thereby completing the process of vacuum sealing the down jacket within the vacuum storage bag 5.

Now, it will be explained how the vacuum storage bag 5 is opened, the effect of opening the vacuum storage bag 5, and how the vacuum storage bag 5 may be reused. To begin opening the vacuum storage bag 5, a worker must first unseal the one-time-use sealing means 45. Unsealing the one-time-use sealing means 45 requires the worker to tear the first panel 10 and the second panel 15 along the tear strip 70. As noted above, the tear strip 70 is simply a portion of the first panel 10 and the second panel 15 that is thinner and weaker than the rest of the vacuum storage bag 5. Thus, as the worker tears the vacuum storage bag 5 along the tear strip 70, the tearing is localized to the weaker portions of the first panel 10 and the second panel 15 provided along the tear strip 70. The presence of the tear notch 75 facilitates the initial tearing of the first panel 10 and the second panel 15 along the tear strip 70.

As discussed above, the vacuum storage bag 5 is provided with a radio frequency identification tag 50 that is positioned collinearly with the tear strip 70 such that the tear strip 70 intersects a portion of the radio frequency identification tag 50. Accordingly, a portion of the radio frequency identification tag 50 antenna is torn and removed from the main body of the radio frequency identification tag 50 as the tear strip 70 is torn to unseal the one-time-use sealing means 45. Removing a portion of the radio frequency identification tag antenna substantially alters the overall shape of the radio frequency identification tag antenna. Because the shape of the radio frequency identification tag antenna dictates the frequency of the radio frequency identification tag, the frequency of the radio identification tag 50 will be altered once the vacuum storage bag 5 is torn along the tear strip 70. A radio frequency identification tag reader will be able to pick up on the different frequencies emitted by an unopened and opened vacuum storage bag, thereby allowing a warehouse to quickly monitor and assess whether a shipment of vacuum storage bags has been tampered with.

Once the one-time-use sealing means 45 have been separated, the only operation left remaining in opening the vacuum storage bag 5 is to release the resealable sealing means 40. To release the resealable sealing means 40, the worker simply pulls the first panel 10 apart from the second panel 15. As the first panel 10 is pulled apart from the second panel 15, the ribs are released from the complementary channels, thereby breaking the seal provided by the resealable sealing means 40. Once the, resealable sealing means 40 have been released, the worker can reach into the storage area 30 through the storage area access opening 35 and retrieve the down jacket.

The vacuum storage bag 5 may be reused once the jacket has been removed. However, the reused vacuum storage bag will not be able to utilize the one-time-use sealing means 45. In theory, the vacuum storage bag 5 may be reused an infinite amount of times, albeit without being able to utilize the one-time-use sealing means 45. However, in practice it is recommended that vacuum storage bag 5 be retired after undergoing a certain number of predetermined vacuum packing and unpacking cycles, as components of the vacuum storage bag 5 may fatigue with repeated use. For example, the valve 55 may become weakened after several use cycles, and thus not be capable of maintaining a vacuum for extended periods of time. Additionally, the first panel 10 and the second panel 15 may become weak or brittle with repeated use. Retiring the vacuum storage bag 5 after the vacuum storage bag 5 has undergone a predetermined number of vacuum packing and unpacking cycles and before the vacuum storage bag 5 ultimately fails reduces the risk of damage to items stored within the vacuum storage bag 5 attributed to vacuum storage bag failure.

It is contemplated that the vacuum storage bag 5 may further be equipped with additional features that serve to protect the articles stored within the vacuum storage bag 5, as well as additional features that serve to both protect the articles stored within the vacuum storage bag 5 while also monitoring the conditions within the storage area 30. For example, it is contemplated that the first panel 10 and the second panel 15 may be provided with ultraviolet light blocking means. The ultraviolet light blocking means could be engineered into the material chosen to manufacture the vacuum storage bag, or alternatively the ultraviolet light blocking means could be provided as a separate film that is applied after the vacuum storage bag 5 is manufactured.

Additionally, it is contemplated that the vacuum storage bag 5 may be provided with moisture sensing means and/or vacuum monitoring means for monitoring the atmospheric conditions within the vacuum storage bag 5 storage area 30. The moisture sensing means and vacuum monitoring means may be simple gauges that use numerals with the appropriate units of measurement to indicate the precise levels of moisture and vacuum in the storage area 30. Alternatively, the moisture sensing means and vacuum monitoring means may consist of gauges that display a color to indicate the conditions within the storage area 30. For example, the gauges may be designed to display the color green, yellow, or red depending on the storage area 30 atmospheric conditions. The gauges would display green if the atmospheric conditions fall within a predetermined acceptable range, yellow if the atmospheric conditions are beginning to approach the outer limits of the acceptable range, and red if the atmospheric conditions fall completely outside the acceptable range.

Besides allowing a worker to monitor the conditions of the storage area 30, the presence of moisture sensing means and/or vacuum monitoring provides several additional benefits. First, the moisture sensing means and the vacuum monitoring means will allow a worker to assess if the vacuum storage bag 5 has developed a leak. If the worker notices that the vacuum level is decreasing and that the moisture level is increasing at an abnormal rate, he or she will be able to conclude that the vacuum storage bag 5 has developed a leak. Second, the vacuum monitoring means will increase the efficiency of the vacuum storage bag packaging process. A worker evacuating the vacuum storage bag 5 using a vacuum source will be able to determine the exact moment that the vacuum storage bag 5 has been fully evacuated. Without the vacuum monitoring means, the worker may let the vacuum source run longer than necessary, thus wasting time and reducing efficiency. Finally, the vacuum monitoring means will allow a worker to package articles within the bag at very specific vacuum levels. The desired level of vacuum at which an article is stored at may vary depending on the properties of the article being stored. For example, it may be undesirable to store a pastry inside the vacuum storage bag at a high level of vacuum, as doing so would result in the pastry becoming compacted, and thus unsatisfactory. The storage of the pastry can be compared with the storage of a comforter inside the vacuum storage bag. Because the comforter will not suffer damaged if the comforter is stored at high levels of vacuum, it may be desirable to store the comforter in the highest attainable level of vacuum so as to reduce the space that the comforter occupies.

Referring now to FIGS. 3, 4, and 6, a second embodiment of a vacuum storage bag 105 is shown. The structure and construction of the second embodiment of the vacuum storage bag 105 is similar to that of the first embodiment of the vacuum storage bag 5 shown in FIGS. 1, 2, and 5.

The second embodiment of the vacuum storage bag 105 has a rectangular first panel 110 and a rectangular second panel 115 manufactured out of a flexible, impermeable material. As discussed in detail above in regards the first embodiment of the vacuum storage bag 5, the first panel 110 and the second panel 115 may be manufactured separately apart from one another as two separate sheets, or the first panel 110 and the second panel 115 may be manufactured together as a single sheet. As can most clearly be seen in FIG. 6, the first panel 110 and the second panel 115 used in the second embodiment of the vacuum storage bag 105 are manufactured together as a single sheet.

The first panel 110 has a first panel periphery 120, while the second panel 115 has a second panel periphery 125. The first panel 110 and the second panel 115 are secured to one another by hermetically sealing together a substantial portion of the first panel periphery 120 and the second panel periphery 125. A storage area 130 is created between the first panel 110 and the second panel 115 once the first panel periphery 120 is secured to the second panel periphery 125. The storage area 130 is provided with a storage area access opening 135. The storage area access opening 135 is located along the portions of the first panel periphery 120 and the second panel periphery 125 that are not hermetically sealed to one another.

The vacuum storage bag 105 has a valve 155 that protrudes from, and is hermetically sealed to, a valve opening 160 provided on the first panel 110. The valve 155 has a valve collar 180 that is made out of a flexible, resilient material.

The vacuum storage bag 105 is provided with resealable sealing means 140 in the form of a plurality of interlocking ribs and channels that extend lengthwise across the storage area access opening 135. The first panel 110 is provided with two ribs that run parallel to one another. The second panel 115 is provided with two channels that run parallel to one another, and are complementary to the ribs.

The vacuum storage bag 105 is further provided with one-time-use sealing means 145 that extend across the storage area access opening 135. The one-time-use sealing means 145 run parallel to, and are located adjacent to, the resealable sealing means 140. In the second embodiment of the vacuum storage bag 105 shown in FIGS. 3, 4, and 6, the one-time use-sealing means consist of a pressure sensitive adhesive. A tear strip 170 is provided between the resealable sealing means 140 and the one-time-use sealing means 145. The tear strip 170 extends across the storage area access opening 135, and runs parallel to both the resealable sealing means 140 and the one-time-use sealing means 145.

The vacuum storage bag 105 has tamper indicating means 150. The presence of tamper indicating means 150 is what differentiates the second embodiment of the vacuum storage bag 105 from the first embodiment of the vacuum storage bag 5. The first embodiment of the vacuum storage bag 5 is not provided with tamper indicating means, but rather, is provided with a radio frequency identification tag 50.

The tamper indicating means 150 extend across the storage area access opening 135 parallel to both the resealable sealing means 140 and the one-time-use sealing means 145. The tamper indicating means 150 are located closer to the storage area 130 than the resealable sealing means 140. However, it is contemplated that the tamper indicating means 150 may also be positioned between the resealable sealing means 140 and the tear strip 170.

In the embodiment of the vacuum storage bag 105 shown in FIGS. 3, 4, and 6, the tamper indicating means 150 consists of a film that appreciably changes appearance once the film has been disrupted. For example, the tamper indicating means 150 may be a film that is initially transparent that becomes colored once the tamper indicating means 150 are disturbed. If this approach is adopted, it is preferable that the tamper indicating means 150 become a bright, highly visible color once the tamper indicating means 150 are disturbed so as to assist a worker in quickly and efficiently ascertaining as to whether the vacuum storage bag 105 has been tampered with. Alternatively, the transparent film of the tamper indicating means may be imprinted with a series of distinct shapes such as a series of “X's”, circles, or triangles. Once the tamper indicating means 150 are disturbed, the series of shapes imprinted on the film would become appreciably distorted. It is contemplated that any other appropriate tamper indicating means may be employed so long as the selected tamper indicating means allow a worker to quickly and efficiently ascertain whether the vacuum storage bag 105 has been tampered with.

Having now described the layout of the second embodiment of the vacuum storage bag 105, the use of the vacuum storage bag 105 will now be explained. First, it will be explained how the vacuum storage bag 105 is used to vacuum seal an article. It should be noted that the operation of the second embodiment of the vacuum storage bag 105 is substantially similar to the first embodiment of the vacuum storage bag 5, the operation of which is described in detail above.

A worker first takes an article and inserts the article into the vacuum storage bag 105 through the storage area access opening 135 and into the storage area 130. Then, the worker flattens the vacuum storage bag 105 around the article. Next, the worker seals the resealable sealing means 140, and then the one-time-use sealing means 145.

With the resealable sealing means 140 and the one-time-use sealing means 145 sealed, the worker can then activate the tamper indicating means 150. To activate the tamper indicating means 150, the worker simply presses down on the portions of the first panel 110 surrounding the tamper indicating means 150 to force the tamper indicating means 150 into the second panel 115.

After the tamper indicating means 150 have been activated, the worker can attach a vacuum source to the valve 155 and activate the vacuum source to evacuate any air remaining within the storage area 130 of the vacuum storage bag 105. Once the vacuum source has completed evacuating the storage area 130, the worker can remove the vacuum source from the valve 155, thereby completing the vacuum sealing process of the second embodiment of the vacuum storage bag 105.

Now, it will be explained how the vacuum storage bag 105 is opened, the effect of opening the vacuum storage bag 105, and how the vacuum storage bag 105 may be reused. To open the vacuum storage bag 105, the worker first separates the one-time-use sealing means 145 by tearing the first panel 110 and the second panel 115 along the tear strip 170. The presence of the tear notch 175 facilitates the initial tearing of the first panel 110 and the second panel 115 along the tear strip 170. Next, the work releases the resealable sealing means 140 by pulling the first panel 110 apart from the second panel 115.

Once the resealable sealing means 140 have been released, all that remains is to release the tamper indicating means 150. To release the tamper indicating means 150, the worker simply separates the first panel 110 surrounding the tamper indicating means 150 from the second panel 115. As discussed above, the appearance of the tamper indicating means 150 will appreciably change once the tamper indicating means 150 have been released. After releasing the tamper indicating means 150, the worker can reach into the vacuum storage bag 105 and retrieve the article stored in the storage area 130. The second embodiment of the vacuum storage bag 105 may be reused once the article has been removed. However, the reused vacuum storage bag 105 will not be able to utilize the one-time-use sealing means or the tamper indicating means 150.

It has thus been seen that an improved vacuum storage bag having assorted monitoring means has been disclosed. While the invention has been described in connection with what is presently considered to be the most practical and preferred embodiment, it will be apparent to those of ordinary skill in the art that the invention is not to be limited to the disclosed embodiment, and that many modifications and equivalent arrangements may be made thereof within the scope of the invention, which scope is to be accorded the broadest interpretation of the appended claims so as to encompass all equivalent structures and products.

What is claimed is:

1. A vacuum storage bag comprising:
a flexible, impermeable bag having a first panel and a second panel, said first panel having a first periphery and said second panel having a second periphery, said first panel and said second panel being hermetically sealed to one another along a substantial portion of said first periphery and said second periphery to define a storage area between said first panel and said second panel and a storage area access opening where said first periphery and said second periphery are not hermetically sealed to one another;
a valve in fluid communication with said storage area, said valve protruding from a valve opening provided on said first panel, said valve being hermetically sealed to said valve opening;
resealable sealing means that extend across said storage area access opening, said resealable sealing means being capable of repeatedly allowing said storage area to be selectively maintained in a substantially hermetically sealed condition or an unsealed condition;
one-time-use sealing means that extend across said storage area opening parallel to said resealable sealing means, said one-time-use sealing means being located further away from said storage area than said resealable sealing means, said one-time-use sealing means being capable of maintaining said storage area in a hermetically sealed condition;
a tear strip extending across said storage area access opening, said tear strip being positioned between said resealable sealing means and said one-time-use sealing means, said tear strip being capable of facilitating the tearing of said first panel and said second panel along said tear strip;
a tear notch located at one end of said tear strip; and
a radio frequency identification tag extending substantially across said storage area access opening, said radio frequency identification tag being positioned collinearly with said tear strip such that said tear strip intersects a portion of said radio frequency identification tag.

2. The vacuum storage bag of claim 1, wherein said first panel and said second panel are manufactured out of biodegradable materials.

3. The vacuum storage bag of claim 1, wherein said first panel and said second panel are provided with ultraviolet light blocking means.

4. The vacuum storage bag of claim 3, wherein said ultraviolet light blocking means are integrated into said first panel and said second panel.

5. The vacuum storage bag of claim 3, wherein said ultraviolet light blocking means are a film applied to said first panel and said second panel.

6. The vacuum storage bag of claim 1, wherein said vacuum storage bag is provided with moisture level sensing means for monitoring the level of moisture within said storage area.

7. The vacuum storage bag of claim 6, wherein said moisture level sensing means are gauges that indicate the exact level of moisture within said storage area.

8. The vacuum storage bag of claim 6, wherein said moisture level sensing means are gauges that display a color to indicate whether the moisture level within said storage area is acceptable.

9. The vacuum storage bag of claim 1, wherein said vacuum storage bag is provided with vacuum level sensing means for monitoring the vacuum level within said storage area.

10. The vacuum storage bag of claim 9, wherein said vacuum level sensing means are gauges that indicate the exact level of vacuum within said storage area.

11. The vacuum storage bag of claim 9, wherein said vacuum level sensing means are gauges that display a color to indicate whether the vacuum level within said storage area is acceptable.

12. The vacuum storage bag of claim 1, wherein said valve is made of a flexible, resilient material to allow said valve to adopt to vacuum sources having a variety of different shapes and sizes.

13. The vacuum storage bag of claim 1, wherein said valve is provided with a protective cap.

14. A vacuum storage bag comprising:
a flexible, impermeable bag having a first panel and a second panel, said first panel having a first periphery and said second panel having a second periphery, said first panel and said second panel being hermetically sealed to one another along a substantial portion of said first periphery and said second periphery to define a storage area between said first panel and said second panel and a storage area access opening where said first periphery and said second periphery are not hermetically sealed to one another;
a valve in fluid communication with said storage area, said valve protruding from a valve opening provided on said second panel, said valve being hermetically sealed to said valve opening;
resealable sealing means that extend across said storage area access opening, said resealable sealing means being capable of repeatedly allowing said storage area to be selective maintained in a substantially hermetically sealed condition or an unsealed condition;
one-time-use sealing means that extend across said storage area opening parallel to said resealable sealing means, said one-time-use sealing means being located further away from said storage area than said resealable sealing means, said one-time-use sealing means being capable of maintaining said storage area in a hermetically sealed condition;
a tear strip extending across said storage area opening, said tear strip being positioned between said resealable sealing means and said one-time-use sealing means, said tear strip being capable of facilitating the tearing of said first panel and said second panel along said tear strip;
a tear notch located at one end of said tear strip; and
tamper indicating means extending across said storage area opening, said temper indicating means being capable of indicating that said vacuum storage bag has been tampered with.

15. The vacuum storage bag of claim 14, wherein said tear strip is positioned between said resealable sealing means and said one-time-use sealing means

16. The vacuum storage bag of claim 14, wherein said first panel and said second panel are manufactured out of biodegradable materials.

17. The vacuum storage bag of claim 14, wherein said first panel and said second panel are provided with ultraviolet light blocking means.

18. The vacuum storage bag of claim 17, wherein said ultraviolet light blocking means are integrated into said first panel and said second panel.

19. The vacuum storage bag of claim 17, wherein said ultraviolet light blocking means are a film applied to said first panel and said second panel.

20. The vacuum storage bag of claim 14, wherein said vacuum storage bag is provided with moisture level sensing means for monitoring the level of moisture within said storage area.

21. The vacuum storage bag of claim 20, wherein said moisture level sensing means are gauges that indicate the exact level of moisture within said storage area.

22. The vacuum storage bag of claim 20 wherein said moisture level sensing means are gauges that display a color to indicate whether the moisture level within said storage area is acceptable.

23. The vacuum storage bag of claim 14, wherein said vacuum storage bag is provided with vacuum level sensing means for monitoring the vacuum level within said storage area.

24. The vacuum storage bag of claim 23, wherein said vacuum level sensing means are gauges that indicate the exact level of vacuum within said storage area.

25. The vacuum storage bag of claim 23, wherein said vacuum level sensing means are gauges that display a color to indicate whether the vacuum level within said storage area is acceptable.

26. The vacuum storage bag of claim 14, wherein said valve is made of a flexible, resilient material to allow said valve to adopt to vacuum sources having a variety of different shapes and sizes.

27. The vacuum storage bag of claim 14, wherein said valve is provided with a protective cap.

28. A method of using a vacuum storage bag comprising the steps of:
providing a flexible, impermeable bag having a storage area, a storage area access opening, a valve in fluid communication with said storage area, resealable sealing means that extend across said storage area access opening, one-time-use sealing means that extend across said storage area access opening, a tear strip that extends across said storage area opening, and a radio frequency identification tag that is positioned collinearly with said tear strip such that said tear strip intersects a portion of said radio frequency identification tag;
placing an article within said storage area through said storage area access opening;
sealing said resealable sealing means;
sealing said one-time-use sealing means;
attaching a vacuum source to said valve;
evacuating all air from said storage area using the vacuum source; and
removing the vacuum source from said valve.

29. The method of claim 28, wherein the method further includes the step of flattening said bag around the article after the step of sealing said one-time-use sealing means.

30. The method of claim 28, wherein said bag is manufactured out of biodegradable materials.

31. The method of claim 28, wherein said bag is provided with ultraviolet light blocking means.

32. The method of claim 31, wherein said ultraviolet light blocking means are integrated into said bag.

33. The method of claim 31, wherein said ultraviolet light blocking means are a film applied to said bag.

34. The method of claim 29, wherein said bag is provided with moisture level sensing means for monitoring the level of moisture within said storage area.

35. The method of claim 34, wherein said moisture level sensing means are gauges that indicate the exact level of moisture within said storage area.

36. The method of claim 34, wherein said moisture level sensing means are gauges that display a color to indicate whether the moisture level within said storage area is acceptable.

37. The method of claim 28, wherein said bag is provided with vacuum level sensing means for monitoring the vacuum level within said storage area.

38. The method of claim 37, wherein said vacuum level sensing means are gauges that indicate the exact level of vacuum within said storage area.

39. The method of claim 37, wherein said vacuum level sensing means are gauges that display a color to indicate whether the vacuum level within said storage area is acceptable.

40. The method of claim 28, wherein said valve is made out of a flexible, resilient material to allow said valve to adopt to vacuum sources having a variety of different shapes and sizes.

41. The method of claim 28, wherein said valve is provided with a protective cap.

42. A method of using a vacuum storage bag comprising the steps of:
providing a flexible, impermeable bag having a storage area, a storage area access opening, a valve in fluid communication with said storage area, resealable sealing means that extend across said storage area access opening, one-time-use sealing means that extend across said storage area access opening, a tear strip that extends across said storage area opening, and tamper indicating means that extend across said storage area opening;
placing an article within said storage area;
sealing said resealable sealing means;
sealing said one-time-use sealing means;
attaching a vacuum source to said valve;
evacuating all air from said storage area using the vacuum source; and
removing the vacuum source from said valve.

43. The method of claim 42, wherein the method further includes the step of flattening said bag around the article after the step of sealing said one-time-use sealing means.

44. The method of claim 42, wherein said bag is manufactured out of biodegradable materials.

45. The method of claim 42, wherein said bag is provided with ultraviolet light blocking means.

46. The method of claim 45, wherein said ultraviolet light blocking means are integrated into said bag.

47. The method of claim 45, wherein said ultraviolet light blocking means are a film applied to said bag.

48. The method of claim 42, wherein said bag is provided with moisture level sensing means for monitoring the level of moisture within said storage area.

49. The method of claim 48, wherein said moisture level sensing means are gauges that indicate the exact level of moisture within said storage area.

50. The method of claim 48, wherein said moisture level sensing means are gauges that display a color to indicate whether the moisture level within said storage area is acceptable.

51. The method of claim 42, wherein said bag is provided with vacuum level sensing means for monitoring the vacuum level within said storage area.

52. The method of claim 51, wherein said vacuum level sensing means are gauges that indicate the exact level of vacuum within said storage area.

53. The method of claim 51, wherein said vacuum level sensing means are gauges that display a color to indicate whether the vacuum level within said storage area is acceptable.

54. The method of claim 42 wherein said valve is made out of a flexible, resilient material to allow said valve to adopt to vacuum sources having a variety of different shapes and sizes.

55. The method of claim 42, wherein said valve is provided with a protective cap.
